(19) United States
(12) Patent Application Publication
(10) Pub. No.: US 2025/0111805 A1
(43) Pub. Date: Apr. 3, 2025

(54) SHELF LABEL MANAGEMENT SYSTEM, SHELF LABEL MANAGEMENT METHOD, AND RECORDING MEDIUM

(71) Applicant: NEC Corporation, Minato-ku, Tokyo (JP)

(72) Inventors: Akira TADA, Tokyo (JP); Hiroki Sugegaya, Tokyo (JP); Yuki Tono, Tokyo (JP); Akihiko Onita, Tokyo (JP)

(73) Assignee: NEC Corporation, Minato-ku, Tokyo (JP)

(21) Appl. No.: 18/728,995

(22) PCT Filed: Feb. 4, 2022
(86) PCT No.: PCT/JP2022/004452

§ 371 Date: Jul. 15, 2024

(51) Int. Cl. G09F 3/20; B65G 1/137; G06Q 10/087

(52) U.S. Cl. CPC G09F 3/208; B65G 1/1371; G06Q 10/087

(57) ABSTRACT

This shelf label system comprises an acquisition unit, location identification unit, linking unit, and first output control unit. For each location in a facility, the acquisition unit acquires data in which location information representing said location and merchandise information relating to merchandise displayed near the location are linked. Upon receipt of an instruction to link the location of an electronic shelf label, the location identification unit identifies location information representing the location where the electronic shelf label has been arranged in the facility. The linking unit links the identified location information and information identifying the electronic shelf label. The first output control unit causes the electronic shelf label to output merchandise information linked with the identified location information.

### TECHNICAL FIELD

The present disclosure relates to a shelf label management system and the like.

### BACKGROUND ART

Electronic shelf labels are widely used in stores. In general, an electronic shelf label displays merchandise information such as a price of merchandise and a name of the merchandise.

For example, PTL 1 describes that a radio tag is attached to a display shelf of merchandise, an electronic shelf label includes a reader for reading the radio tag, and the reader for reading reads merchandise display location information of the radio tag close to the electronic shelf label when the electronic shelf label is installed to be close to the radio tag.

### CITATION LIST

### Patent Literature

PTL 1: JP 2008-280140 A

### SUMMARY OF INVENTION

### Technical Problem

If a large number of electronic shelf labels exist in a case where the electronic shelf labels are to be linked with pieces of location information of a facility, it takes time and effort to use the electronic shelf labels.

An object of the present disclosure is to provide a shelf label management system and the like that save time and effort required to install an electronic shelf label.

### Solution to Problem

A shelf label management system according to an aspect of the present disclosure includes: an acquisition means for acquiring, for each location in a facility, data in which location information representing the location and merchandise information relating to merchandise displayed near the location are linked; a location identification means for identifying location information representing a location where an electronic shelf label is arranged in the facility upon receipt of an instruction to link the location of the electronic shelf label; a linking means for linking the identified location information and shelf label identification information of the electronic shelf label; and a first output control means for outputting merchandise information linked with the identified location information to the electronic shelf label based on the acquired data.

A shelf label management method according to an aspect of the present disclosure includes: acquiring, for each location in a facility, data in which location information representing the location and merchandise information relating to merchandise displayed near the location are linked; identifying location information representing a location where an electronic shelf label is arranged in the facility upon receipt of an instruction to link the location of the electronic shelf label; linking the identified location information and shelf label identification information of the electronic shelf label; and outputting merchandise information linked with the identified location information to the electronic shelf label based on the acquired data.

A program according to one aspect of the present disclosure causes a computer to execute processing of: acquiring, for each location in a facility, data in which location information representing the location and merchandise information relating to merchandise displayed near the location are linked; identifying location information representing a location where an electronic shelf label is arranged in the facility upon receipt of an instruction to link the location of the electronic shelf label; linking the identified location information and shelf label identification information of the electronic shelf label; and outputting merchandise information linked with the identified location information to the electronic shelf label based on the acquired data.

The program may be stored in a non-transitory computer-readable recording medium.

### Advantageous Effects of Invention

According to the present disclosure, it is possible to save the time and effort required to install the electronic shelf label.

### BRIEF DESCRIPTION OF DRAWINGS

FIG. 1 is an explanatory view illustrating an example of a store and shelves installed in the store.

FIG. 2 is an explanatory diagram illustrating an example of connection between a shelf label management system according to a first example embodiment and other devices.

FIG. 3 is an explanatory view illustrating an example of an electronic shelf label.

FIG. 4 is a block diagram illustrating a configuration example of the shelf label management system according to the first example embodiment.

FIG. 5 is a view illustrating an example before store location information in a store is linked with the electronic shelf label.

FIG. 6 is a view illustrating an example in which store location information in the store is identified on the electronic shelf label.

FIG. 7 is a view illustrating an example in which merchandise information linked with the store location information is displayed on the electronic shelf label.

FIG. 8 is a flowchart illustrating Operation Example 1 regarding linkage of a location by the shelf label management system according to the first example embodiment.

FIG. 9 is an explanatory view illustrating an example before different pieces of merchandise information are linked with a plurality of the electronic shelf labels, respectively.

FIG. 10 is an explanatory view illustrating an example in which the different piece of merchandise information are linked with the plurality of electronic shelf labels, respectively.

FIG. 11 is a flowchart illustrating Operation Example 2 regarding linkage of a location by the shelf label management system according to the first example embodiment.

FIG. 12 is an explanatory view illustrating a first example of location designation in an image of a store.

FIG. 13 is an explanatory view illustrating an example of electronic shelf labels in a real store.

FIG. 14 is an explanatory view illustrating an example in which merchandise information displayed on a selected electronic shelf label is displayed on a terminal device.

FIG. 15 is an explanatory view illustrating an example of changing the merchandise information to be displayed on the selected electronic shelf label.

FIG. 16 is an explanatory view illustrating a second example of location designation in an image of a store.

FIG. 17 is an explanatory view illustrating an example in which the merchandise information displayed on the selected electronic shelf label is displayed on the terminal device.

FIG. 18 is a flowchart illustrating an operation example regarding selection of an electronic shelf label by the shelf label management system according to the first example embodiment.

FIG. 19 is an explanatory view illustrating an example in which an electronic shelf label is present in an area different from an area of linked merchandise.

FIG. 20 is an explanatory view illustrating Notification Example 1.

FIG. 21 is an explanatory view illustrating Notification Example 2.

FIG. 22 is a flowchart illustrating an operation example regarding notification of a shift of a location of an electronic shelf label by the shelf label management system according to the first example embodiment.

FIG. 23 is a block diagram illustrating a configuration example of a shelf label management system according to a second example embodiment.

FIG. 24 is a flowchart illustrating an operation example of the shelf label management system according to the second example embodiment.

FIG. 25 is an explanatory diagram illustrating a hardware configuration example of a computer.

### EXAMPLE EMBODIMENT

Hereinafter, example embodiments of a shelf label management system, a shelf label management method, a program, and a non-transitory recording medium recording the program according to the present disclosure will be described in detail with reference to the drawings. The present example embodiments do not limit the disclosed technology.

In each of the example embodiments, a facility is, for example, a store, a factory, a warehouse, or the like without being particularly limited to be outdoor or indoor. Furthermore, furniture on which an electronic shelf label is installed is not particularly limited, such as a shelf or a basket.

### First Example Embodiment

In the first example embodiment, a store is taken as an example of a facility, a shelf is taken as an example of furniture, and an example of controlling an output of an electronic shelf label arranged on the shelf installed in the store will be described. Therefore, location information is also referred to as store location information.

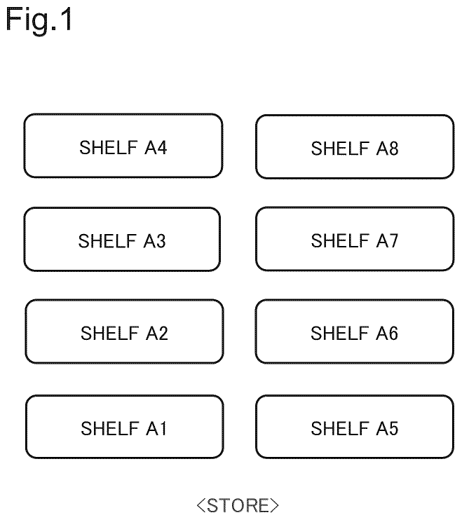

FIG. 1 is an explanatory view illustrating an example of a store and shelves installed in the store. In FIG. 1, a plurality of shelves A1 to A8 are installed in the store.

Here, the store may be, for example, a store such as a supermarket, a superstore, a convenience store, a mass merchandiser, a home center, a drug store, a store that handles apparel merchandise, or a private shop such as a bakery or a daily dish store, and is not particularly limited.

The number of shelves is an example, and is one or more, and is not particularly limited.

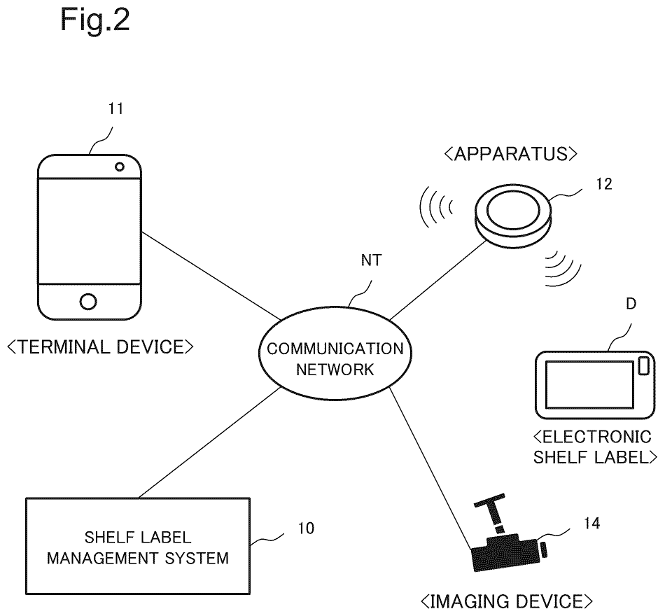

FIG. 2 is an explanatory diagram illustrating an example of connection between a shelf label management system according to the first example embodiment and other devices. A shelf label management system 10 is connected to a terminal device 11, an apparatus 12, an imaging device 14, and the like via a communication network NT. In FIG. 2, one communication network NT is exemplified for ease of description, but the shelf label management system 10 may be connected to each device and each apparatus via different communication networks NT. The apparatus 12 is a beacon device or an infrared communication device.

The shelf label management system 10 controls an output of an electronic shelf label D via the apparatus 12. Specifically, the shelf label management system 10 transmits information for control to the apparatus 12, and the apparatus 12 transmits the information for control to the electronic shelf label D. Here, the apparatus 12 and the electronic shelf label D can transmit and receive data by infrared communication and wireless communication.

In the first example embodiment, one terminal device 11 will be described as an example for ease of description, but the shelf label management system 10 may be connected to a plurality of terminal devices 11. Furthermore, the imaging device 14 is a device that is installed in the store and can capture an image of a shelf on which the electronic shelf label D is installed. The number of the imaging devices 14 is not particularly limited.

Furthermore, the apparatus 12 has a function of performing near field communication with the electronic shelf label D. For example, the apparatus 12 is a beacon device or the like. Alternatively, the apparatus 12 has a function of being able to communicate with the electronic shelf label D by infrared rays. For example, the apparatus 12 is an infrared communication device.

The number of the apparatuses 12 is not particularly limited as long as the number enables identification of a location of the electronic shelf label D.

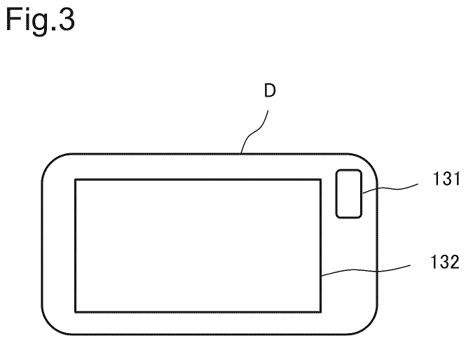

The number of electronic shelf labels D is not particularly limited. The electronic shelf label D will be described with reference to FIG. 3.

FIG. 3 is an explanatory view illustrating an example of the electronic shelf label D. The electronic shelf label D includes, for example, a light emitting diode (LED) 131 and a display device 132. The LED 131 is an example of a lighting device, and a type of the lighting device is not particularly limited. The display device 132 may be electronic paper or a liquid crystal display (LCD), and is not particularly limited. The LED 131 and the display device 132 are provided on a front surface or the like of the electronic shelf label D. Although not illustrated, for example, a hook or the like is provided on a back surface of the electronic shelf label D, and the electronic shelf label D is installed on the shelf by the hook.

Although not illustrated, the electronic shelf label D has a function of being able to perform infrared communication with the apparatus 12 and the terminal device 11. Since the infrared communication is used, power consumption of the electronic shelf label D can be suppressed.

Alternatively, the electronic shelf label D may have a function of being able to perform wireless communication with the apparatus 12 and the terminal device 11.

The configuration of the electronic shelf label D is an example, and is not particularly limited.

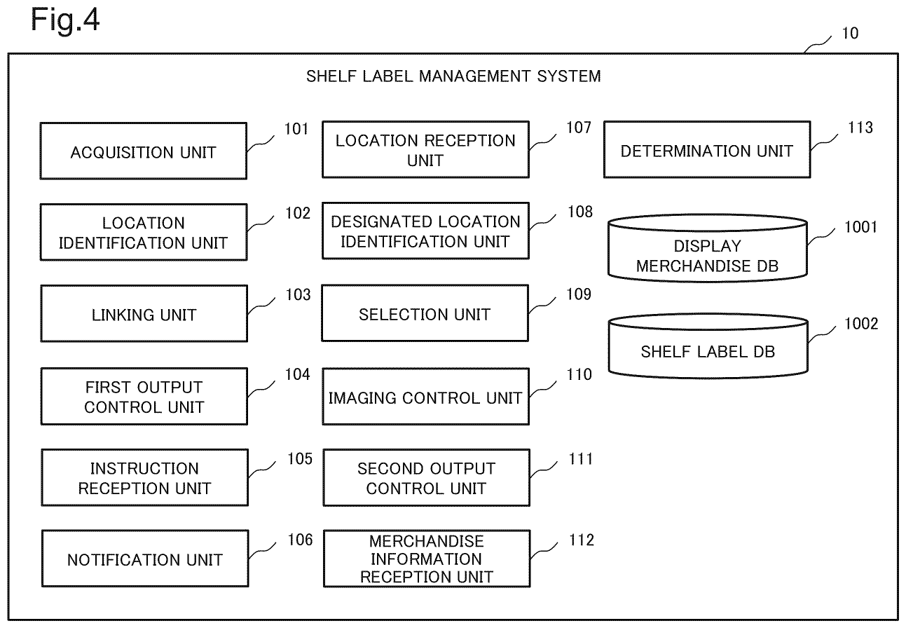

FIG. 4 is a block diagram illustrating a configuration example of the shelf label management system 10 according to the first example embodiment. The shelf label management system 10 includes an acquisition unit 101, a location identification unit 102, a linking unit 103, a first output control unit 104, an instruction reception unit 105, a notification unit 106, a location reception unit 107, a designated location identification unit 108, a selection unit 109, an imaging control unit 110, a second output control unit 111, a merchandise information reception unit 112, and a determination unit 113.

Furthermore, the shelf label management system 10 includes a display merchandise database (DB) 1001 and a shelf label DB 1002. The display merchandise DB 1001 stores, for each location in the store, store location information representing a location in the store and merchandise information of merchandise to be output to the electronic shelf label D displayed near the location in linkage with each other. An expression format of the store location information is not particularly limited as long as the location in the store can be identified. Each location in the store may be a location of a passage, a location of a shelf, a location on a shelf such as a shelf and a tier of the shelf, above or below the shelf, or left or right of the shelf, or a location representing an area where merchandise is displayed. Specifically, for example, the store location information may be location information representing a location of a passage, location information representing a location of a shelf, location information representing a location on a shelf such as a shelf and a tier of the shelf, above or below the shelf, or left or right of the shelf, or may be a coordinate value in the store, or may be identification information for identifying the apparatus 12 used to measure a location of the electronic shelf label D, and is not particularly limited. The merchandise information is not particularly limited as long as the information relates to merchandise to be displayed on the display device 132 of the electronic shelf label D, such as a name of merchandise or a price of merchandise.

Furthermore, the shelf label DB 1002 stores, for each of the electronic shelf labels D, store location information representing a location in the store where the electronic shelf label D is installed. For example, the shelf label DB 1002 stores shelf label identification information of the electronic shelf label D and the store location information in linkage with each other. For example, before receipt of an instruction to link a location with each of the electronic shelf labels D, the store location information linked with the shelf label identification information of the electronic shelf label D in the shelf label DB 1002 may be empty.

Next, functional units will be described.

<Example of Linking Store Location Information with Electronic Shelf Label D>

First, an example of linking store location information in a store with the electronic shelf label D will be described.

The instruction reception unit 105 receives an instruction to link a location of the electronic shelf label D. For example, the instruction reception unit 105 may receive the indication to link the location of the electronic shelf label D by an operation of a user on the terminal device 11. The instruction reception unit 105 may receive the linkage instruction for each of the electronic shelf labels D, or may collectively receive the linkage instruction for a plurality of electronic shelf labels D. For example, in a case where the facility is the store, the user may be a clerk. The clerk may input, to the terminal device 11, the instruction to link the location of the electronic shelf label D after taking the electronic shelf label D to the shelf. Then, the instruction reception unit 105 receives the instruction to link the location of the electronic shelf label D by an operation of the clerk.

Next, when the instruction reception unit 105 receives the instruction to link the location of the electronic shelf label D, the location identification unit 102 identifies store location information representing the location of the electronic shelf label D in the store. Specifically, for example, the location identification unit 102 identifies the location of the electronic shelf label D in the store. For example, the location identification unit 102 measures the location of the electronic shelf label D based on communication strength of wireless communication between the apparatus 12 fixedly arranged in the store and the electronic shelf label D. Alternatively, for example, the location identification unit 102 measures the location of the electronic shelf label D based on communication strength of infrared communication between the apparatus 12 fixedly arranged in the store and the electronic shelf label D.

The linking unit 103 links the identified store location information and shelf label identification information of the electronic shelf label D. Specifically, for example, the linking unit 103 outputs the shelf label identification information and the identified store location information in linkage with each other. Outputting in linkage means that, for example, the linking unit 103 stores the shelf label identification information and the identified store location information in linkage with each other in the shelf label DB 1002 or the like.

The first output control unit 104 outputs merchandise information linked with the store location information to the electronic shelf label. Specifically, for example, the first output control unit 104 displays the merchandise information on the display device 132 of the electronic shelf label D. More specifically, for example, the first output control unit 104 displays the merchandise information on the display device 132 of the electronic shelf label D by wireless communication via the apparatus 12 fixedly arranged in the store. Alternatively, for example, the first output control unit 104 displays the merchandise information on the display device 132 of the electronic shelf label D by infrared communication via the apparatus 12 fixedly arranged in the store.

In a case where the identified store location information is already linked with shelf label identification information of another electronic shelf label D, the linking unit 103 does not necessarily link the shelf label identification information of the electronic shelf label D and the identified store location information. Since another electronic shelf label D has already been allocated, the second output control unit 111 may notify the clerk to install the electronic shelf label D at another place. As a notification method, the second output control unit 111 gives a notification to the terminal device 11 of the clerk.

An example in which store location information is linked with the electronic shelf label D will be described with reference to the drawings.

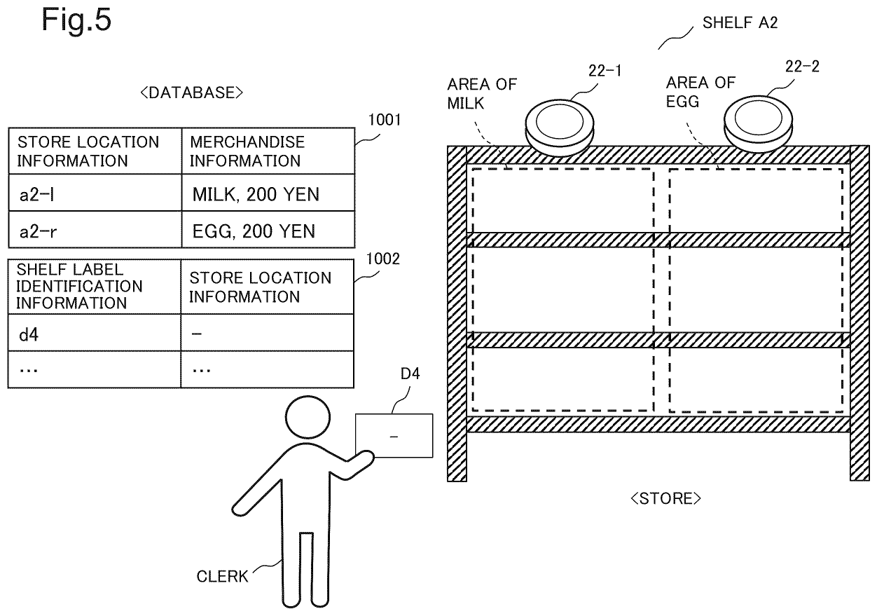

FIG. 5 is a view illustrating an example before store location information in a store is linked with the electronic shelf label D.

In FIG. 5, a shelf A2 includes an area where milk is displayed and an area where an egg is displayed. In FIG. 5, for example, store location information of the area where milk is displayed is a2-1. On the other hand, store location information of the area where the egg is displayed is a2-r. Furthermore, an apparatus 12-1 capable of identifying the store location information a2-1 and an apparatus 12-2 capable of identifying the store location information a2-r are installed on the shelf.

In FIG. 5, in the shelf label DB 1002, store location information of an electronic shelf label D4 is empty. For example, the clerk takes the electronic shelf label D to the shelf and installs the electronic shelf label D on the shelf.

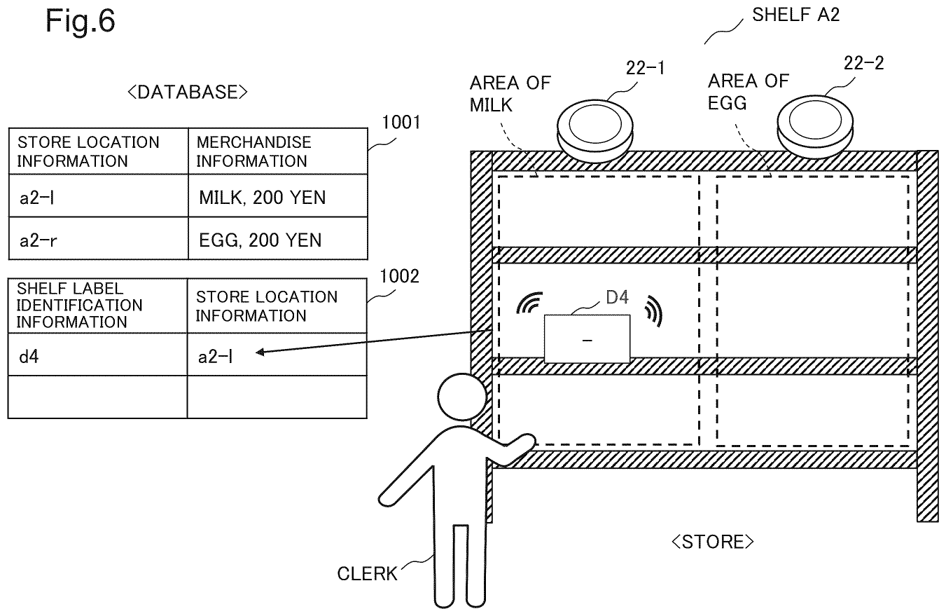

FIG. 6 is a view illustrating an example in which store location information in the store is identified on the electronic shelf label D. When the instruction reception unit 105 receives an instruction to link a location of the electronic shelf label D, the location identification unit 102 identifies store location information representing the location of the electronic shelf label D in the store by wireless communication or infrared communication via the apparatus 12 fixedly arranged in the store. In FIG. 6, the store location information a2-1 is identified. The linking unit 103 links the store location information a2-1 and shelf label identification information d4 of the electronic shelf label D4. For example, the linking unit 103 stores the store location information a2-1 and the shelf label identification information d4 of the electronic shelf label D4 in the shelf label DB 1002 in linkage with each other. As a result, the shelf label identification information d4 of the electronic shelf label D4 and merchandise information are linked with each other via the shelf label DB 1002 and the display merchandise DB 1001.

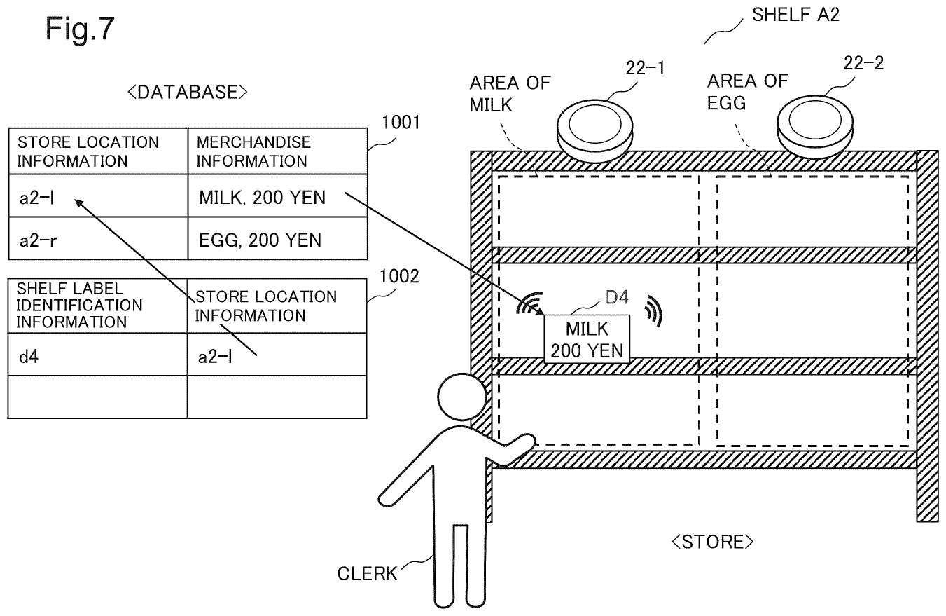

FIG. 7 is a view illustrating an example in which merchandise information linked with the store location information is displayed on the electronic shelf label D. The first output control unit 104 outputs merchandise information linked with the store location information a2-1 to the display device 132 of the electronic shelf label D4. The store location information a2-1 is linked with a merchandise name “milk” and a price “200 yen” as the merchandise information. Therefore, the merchandise name “milk” and the price “200 yen” are displayed on the electronic shelf label D1.

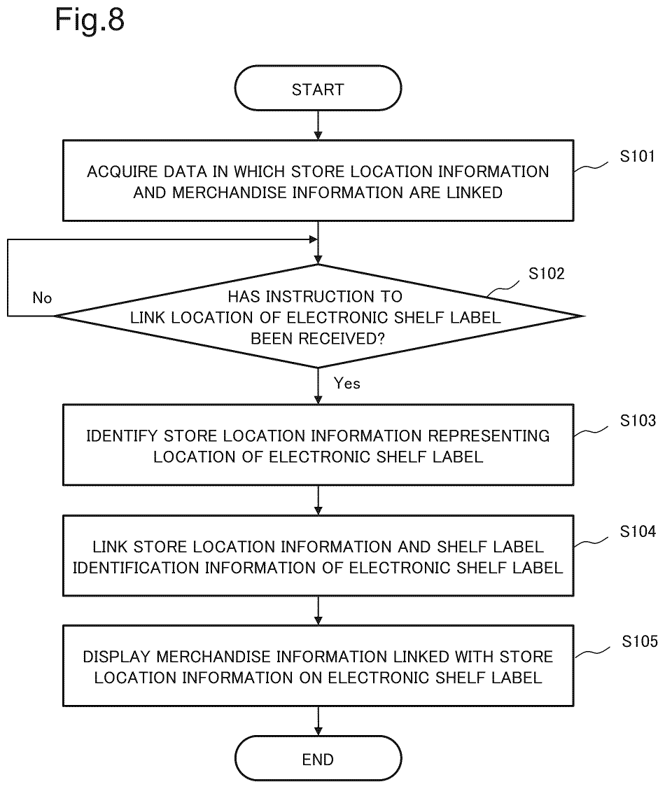

FIG. 8 is a flowchart illustrating Operation Example 1 regarding linkage of a location by the shelf label management system 10 according to the first example embodiment. The acquisition unit 101 acquires data in which store location information and merchandise information are linked (step S101). Here, for example, in step S101, the acquisition unit 101 may acquire the display merchandise DB 1001. The location reception unit 107 determines whether an instruction to link a location of the electronic shelf label D has been received (step S102). In a case where the instruction to link a location of the electronic shelf label D has not been received (step S102: No), the store reception unit returns to step S102.

In a case where the instruction to link a location of the electronic shelf label D has been received (step S102: Yes), the location identification unit 102 identifies store location information representing the location of the electronic shelf label D (step S103). In step S103, the location identification unit 102 measures the location of the electronic shelf label D by wireless communication or infrared communication using the apparatus 12 fixedly arranged in the store.

Next, the linking unit 103 links shelf label identification information of the electronic shelf label D with the store location information (step S104). In step S104, the linking unit 103 stores the shelf label identification information of the electronic shelf label D and the store location information in the shelf label DB 1002 in linkage with each other.

The first output control unit 104 displays the merchandise information linked with the store location information on the electronic shelf label D based on the acquired display merchandise DB 1001 and shelf label DB 1002 (step S105). In step S105, the location identification unit 102 displays the merchandise information on the display device 132 of the electronic shelf label D by wireless communication or infrared communication using the apparatus 12 fixedly arranged in the store.

In a case where the electronic shelf label D is linked with store location information in the store, it takes time and effort of the clerk if a large number of the electronic shelf labels D exist. As described above, in the first example embodiment, the shelf label management system 10 acquires, for each location in a facility, data in which location information representing the location and merchandise information of merchandise displayed near the location are linked. Then, upon receipt of an instruction to link a location of the electronic shelf label D, the shelf label management system 10 identifies location information representing the location where the electronic shelf label D is arranged in the facility, links identification information of the electronic shelf label D with the identified location information, and outputs merchandise information linked with the identified location information to the electronic shelf label D. As a result, it is possible to save the time and effort of the clerk in the case of linking the store location information with the electronic shelf label D. As compared with a case where the electronic shelf label D reads location information from an electronic tag or the like, it is sufficient for the electronic shelf label D to communicate with the apparatus 12 that is typically provided in the first example embodiment, and thus, cost for the electronic tag or the like is not required, and cost reduction can be achieved.

<Example of Linking Location Information with n Electronic Shelf Labels D>

Next, a case where there are n electronic shelf labels D, and merchandise information of m pieces of merchandise is linked with store location information will be described as an example. Here, the m pieces of merchandise are mutually different pieces of merchandise. Therefore, the store location information is linked with the merchandise information of each of the m pieces of merchandise.

The location identification unit 102 identifies location information for each of the plurality of electronic shelf labels D.

When pieces of the location information identified for a plurality of electronic shelf labels D are the same, the linking unit 103 links the identified location information with shelf label identification information of each of the plurality of electronic shelf labels D. Specifically, for example, when linking shelf label identification information with merchandise information, the linking unit 103 may store the shelf label identification information and the merchandise information linked with location information in a storage unit in linkage with each other. Alternatively, in a case where store location information in the display merchandise DB 1001 is divided in more detail than the accuracy of a location that can be identified by the apparatus 12, the store location information and merchandise information may be linked in advance in the display merchandise DB 1001, and the linking unit 103 may store shelf label identification information and the store location information in the shelf label DB 1002 in linkage with each other. In the following description, the case where store location information in the display merchandise DB 1001 is divided in more detail than the accuracy of a location that can be identified by the apparatus 12 will be described as an example.

For example, when pieces of store location information identified for the n electronic shelf labels D are the same, if n and m are the same, the linking unit 103 links shelf label identification information of the electronic shelf label D with the store location information such that different pieces of merchandise information are allocated to the n electronic shelf labels D, respectively. Allocating different pieces of merchandise information respectively to the n electronic shelf labels D means that displaying different pieces of merchandise information respectively on the n electronic shelf labels D.

Furthermore, in a case where a number n of the plurality of electronic shelf labels D is larger than a number m of pieces of merchandise identified by merchandise information linked with identified store location information, the linking unit 103 links the store location information such that different pieces of merchandise information are allocated, respectively, to pieces of shelf label identification information of m electronic shelf labels D among the plurality of electronic shelf labels D. However, the linking unit 103 does not necessarily link store location information with pieces of shelf label identification information of the number of electronic shelf labels D exceeding the number m of pieces of merchandise among the plurality of electronic shelf labels D.

Then, the first output control unit 104 displays the merchandise information linked with the store location information on the electronic shelf label D based on the display merchandise DB 1001. The clerk may visually confirm the display and move an electronic shelf label to an appropriate location on the shelf based on the merchandise information displayed on each of the electronic shelf labels D.

Furthermore, since no merchandise information is displayed on the number of electronic shelf labels D exceeding the number m of pieces of merchandise, it is sufficient for the clerk to collect the electronic shelf labels D on which no merchandise information is displayed.

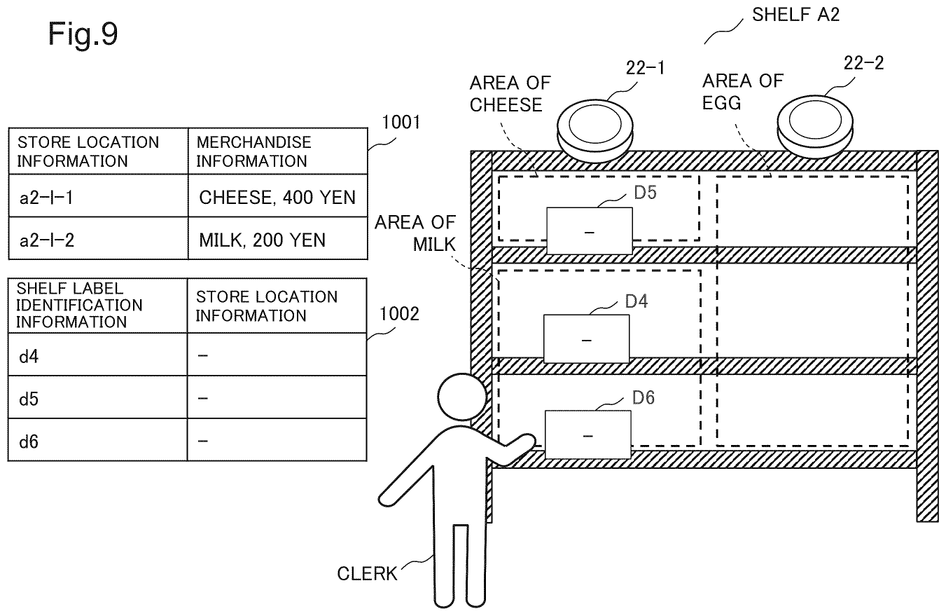

FIG. 9 is an explanatory view illustrating an example before different pieces of merchandise information are linked with a plurality of electronic shelf labels D, respectively. In FIG. 9, although the store location information a2-1 can be identified by the apparatus 12, the store location information a2-1 is divided into store location information a2-1-1 and store location information a2-1-2 in more detail. In the store location information a2-1-1, a merchandise name “cheese” and a price “400 yen” are linked as merchandise information. In the store location information a2-1-2, a merchandise name “milk” and a price “200 yen” are linked as merchandise information.

In FIG. 9, the clerk arranges electronic shelf labels D4 to D6 on the left side of the shelf. Then, when the instruction reception unit 105 receives an instruction to link a location of the electronic shelf label D, the location identification unit 102 identifies store location information representing the location in the store for each of the electronic shelf labels D. Here, the store location information a2-1 is identified.

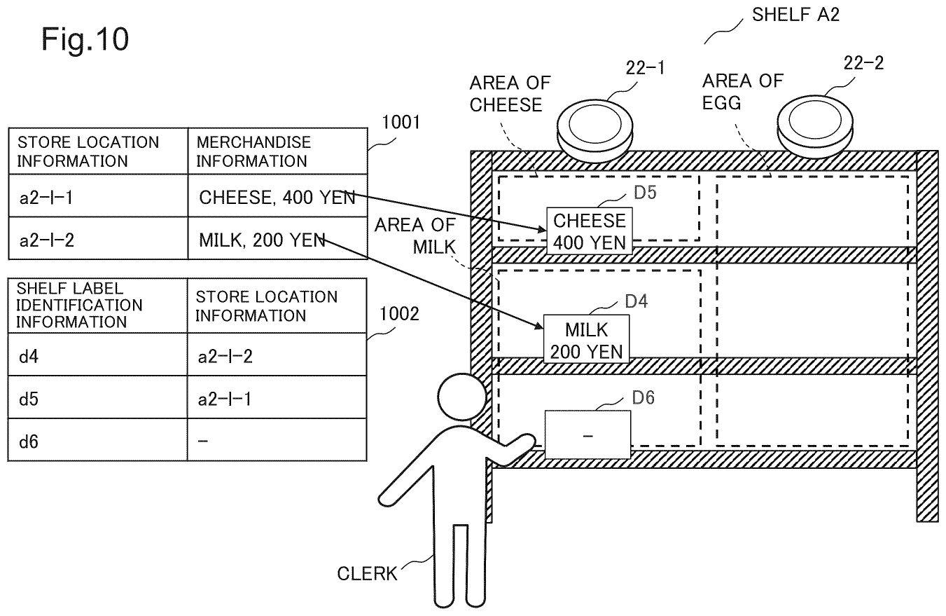

FIG. 10 is an explanatory view illustrating an example in which the different pieces of merchandise information are linked with the plurality of electronic shelf labels D, respectively. When pieces of store location information identified for the plurality of electronic shelf labels D are the same, the linking unit 103 links location information such that different pieces of merchandise information are linked with pieces of shelf label identification information of the plurality of electronic shelf labels D, respectively.

Specifically, for example, the linking unit 103 links the shelf label identification information d4 of the electronic shelf label D4 and the store location information a2-1-2. As a result, the shelf label identification information d4 of the electronic shelf label D4 is linked with the merchandise information including the merchandise name “milk” and the price “200 yen”. Specifically, for example, the linking unit 103 links shelf label identification information d5 of the electronic shelf label D5 and the store location information a2-1-1. As a result, the shelf label identification information d5 of the electronic shelf label D5 is linked with the merchandise information including the merchandise name “cheese” and the price “400 yen”.

Then, for example, the linking unit 103 does not link any store location information with shelf label identification information d6 of the electronic shelf label D6.

The first output control unit 104 displays the merchandise information linked with the store location information on the electronic shelf label D4 based on the display merchandise DB 1001. Then, the first output control unit 104 displays the merchandise information linked with the store location information on the electronic shelf label D5 based on the display merchandise DB 1001.

For example, there is a case where the store location information a2-1-2 is linked with the electronic shelf label D4 installed in an area of milk, and the store location information a2-1-1 is linked with the electronic shelf label D5 installed in an area of cheese. In this case, the merchandise information including the merchandise name “cheese” and the price “400 yen” is displayed on the electronic shelf label D4, and the merchandise information including the merchandise name “milk” and the price “200 yen” is displayed on the electronic shelf label D5. In such a case, it is sufficient for the clerk to confirm the display of the electronic shelf label D5 and the display of the electronic shelf label D4 and replace the electronic shelf labels at appropriate locations.

Since the electronic shelf label D6 is not linked with any store location information, no merchandise information is displayed. Therefore, the clerk may confirm that no merchandise information is displayed on the electronic shelf label D6 and collect the electronic shelf label D6.

Furthermore, in a case where the number n of electronic shelf labels D is smaller than the number m of pieces of merchandise, the notification unit 106 may notify the clerk that the number of electronic shelf labels D is insufficient. Specifically, for example, the notification unit 106 notifies the terminal device 11 of the clerk that the number of electronic shelf labels D is insufficient. Furthermore, the notification unit 106 may notify the terminal device 11 of the clerk of a shortage of the electronic shelf labels D.

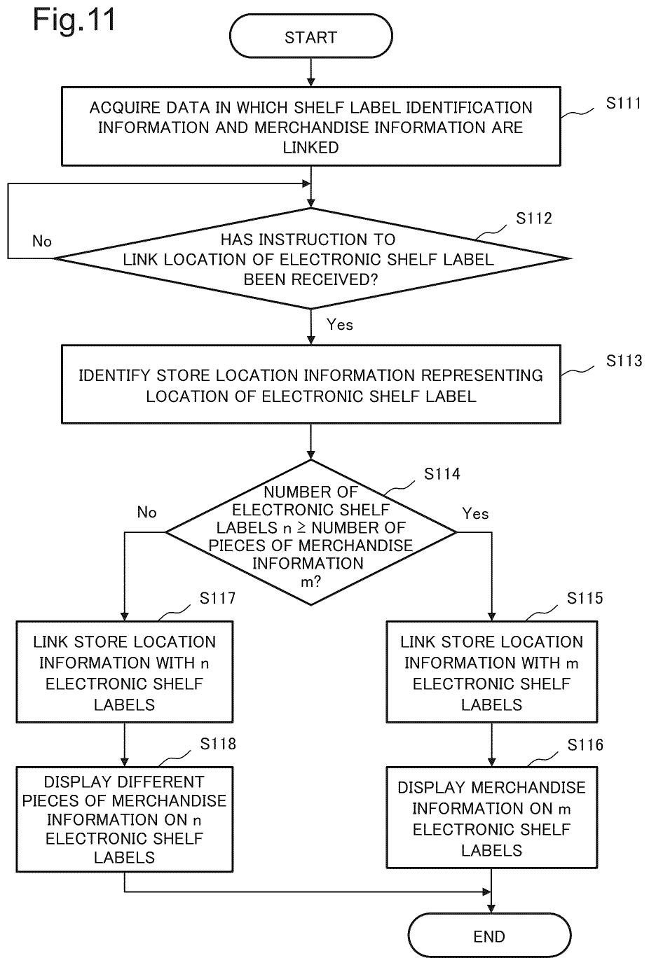

FIG. 11 is a flowchart illustrating Operation Example 2 regarding linkage of a location by the shelf label management system 10 according to the first example embodiment. The acquisition unit 101 acquires data in which shelf label identification information and merchandise information are linked (step S111). Then, the location reception unit 107 determines whether an instruction to link a location of the electronic shelf label D has been received (step S112). In a case where the instruction to link a location of the electronic shelf label D has not been received (step S112: No), the location reception unit 107 returns to step S112.

In a case where the instruction to link a location of the electronic shelf label D has been received (step S112: Yes), the location identification unit 102 identifies store location information representing the location of the electronic shelf label D (step S113). In step S113, the location identification unit 102 measures the location of the electronic shelf label D by wireless communication or infrared communication using the apparatus 12 fixedly arranged in the store.

Next, the linking unit 103 determines whether the number n of electronic shelf labels D is equal to or larger than the number m of pieces of merchandise (step S114). As described above, the number m of pieces of merchandise is the number of pieces of merchandise identified by merchandise information linked with the identified store location information.

In a case where the number n of electronic shelf labels D is equal to or larger than the number m of pieces of merchandise (step S114: Yes), the linking unit 103 links the store location information with pieces of shelf label identification information for identifying the m electronic shelf labels D such that pieces of the merchandise information linked with the identified store location information are different (step S115). In step S115, the linking unit 103 does not link the store location information with more than m electronic shelf labels D. The first output control unit 104 displays pieces of the merchandise information linked with the store location information on the m electronic shelf labels D (step S116), and ends the processing.

In a case where the number n of electronic shelf labels D is not equal to or larger than the number m of pieces of merchandise (step S114: No), the linking unit 103 links the store location information with the n electronic shelf labels D such that pieces of the merchandise information linked with the identified store location information are different from each other (step S117). The first output control unit 104 displays pieces of the linked merchandise information on the n electronic shelf labels D (step S118), and ends the processing.

As described above, in the first example embodiment, when pieces of location information identified for a plurality of electronic shelf labels D are the same, the shelf label management system 10 links the store location information such that different pieces of merchandise information are linked with pieces of shelf label identification information of the plurality of electronic shelf labels D, respectively. Then, the shelf label management system 10 displays the merchandise information linked with the store location information on the display device 132 of each of the plurality of electronic shelf labels D. As a result, the merchandise information is displayed on a necessary number of electronic shelf labels D when the clerk just arranges the n electronic shelf labels D around the shelf. Therefore, time and effort of the clerk can be saved.

### <Example of Selection of Electronic Shelf Label D>

Next, an example in which a user selects the electronic shelf label D will be described. In a case where a facility is a store, the user is, for example, a clerk or a customer. In a case where the facility is a warehouse or a factory, the user is, for example, a worker.

The acquisition unit 101 acquires data in which shelf label identification information and store location information are linked. As described above, for example, the shelf label DB 1002 stores, for each of the electronic shelf labels D, shelf label identification information for identifying the electronic shelf label D and store location information representing a location in the store in linkage with each other. Therefore, for example, the acquisition unit 101 acquires the shelf label DB 1002 as this data.

The location reception unit 107 receives designation of a location in the store by a user operation. A method for designating the location is not particularly limited. For example, the location reception unit 107 receives designation of a location on an image in the store by a user operation. Here, the user operation is, for example, a user operation on the terminal device 11. The image here may be an image representing a map of the store or an image of each shelf provided in the store.

The designated location identification unit 108 identifies store location information relevant to the designated location. Here, each location on the image and store location information in the store relevant to this location may be linked in advance and stored as a DB. In this case, the designated location identification unit 108 identifies the store location information linked with the designated location. Alternatively, the designated location identification unit 108 may identify the store location information from a location of the imaging device 14 that has captured the image and an angle of view of the image. Alternatively, the designated location identification unit 108 may identify a shelf near an area of the designated location from the image, and identify the store location information from a location of the shelf.

The selection unit 109 selects the electronic shelf label D identified by shelf label identification information linked with the store location information based on the acquired data. Specifically, for example, the selection unit 109 identifies shelf label identification information linked with the store location information from the shelf label DB 1002, and selects the electronic shelf label D identified by the identified shelf label identification information.

The first output control unit 104 controls an output of the selected electronic shelf label D.

For example, the first output control unit 104 may turn on a lighting device of the selected electronic shelf label D.

For example, a first output control means may output new merchandise information to the selected electronic shelf label D. The new merchandise information may be received from the user. When the new merchandise information is received from the user, for example, the merchandise information reception unit 112 receives the new merchandise information by an operation of the customer on the terminal device 11. The merchandise information reception unit 112 may update merchandise information linked with the identified store location information to the received merchandise information in the display merchandise DB 1001. Then, the first output control unit 104 displays the updated merchandise information on the display device 132 of the selected electronic shelf label D.

Furthermore, the second output control unit 111 may output the merchandise information output to the selected electronic shelf label D to the terminal device 11 of the user.

For example, the user may confirm the merchandise information displayed on the terminal device 11, and then, update the merchandise information. In such a case, after the second output control unit 111 outputs the merchandise information output to the selected electronic shelf label D to the terminal device 11 of the user, the first output control unit 104 displays the new merchandise information on the display device 132 of the selected electronic shelf label D.

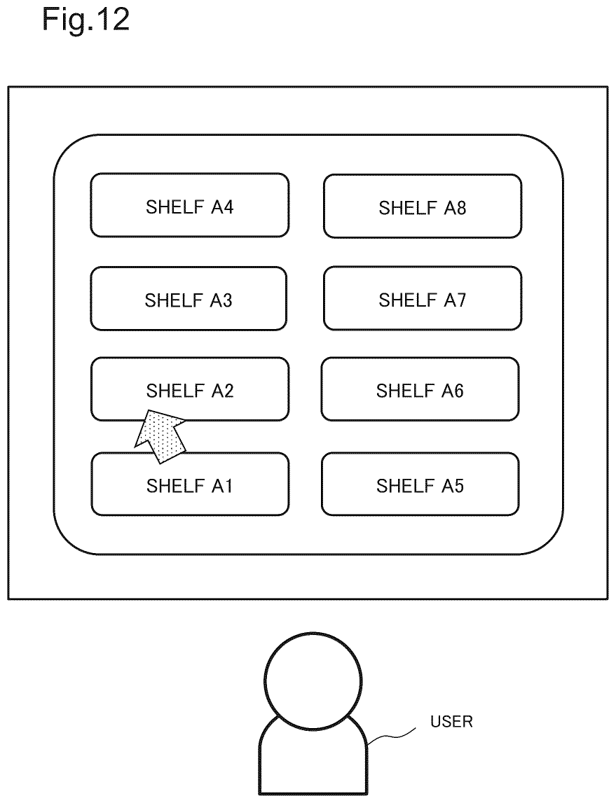

FIG. 12 is an explanatory view illustrating a first example of location designation on an image of a store. The second output control unit 111 displays the image of the store on the display device of the terminal device 11. In FIG. 12, a screen including the image of the store is displayed on the terminal device 11. In FIG. 12, the image of the store is an image representing a sales floor of the store, and is, for example, an image including a plurality of shelves installed in the store. The image of the store may be a map of the sales floor of the store. The image of the store may be a picture image or a captured image. Shelf identification information that enables identification of a shelf may be superimposed on the image of the store.

The location reception unit 107 receives designation of a location on the image of the store by a user operation. In FIG. 12, a mark indicating the location designated by the user operation may be displayed on the screen. In FIG. 12, this mark is an arrow.

Upon receipt of the designation of the location, the terminal device 11 transmits information representing the received location to the shelf label management system 10. Then, the location reception unit 107 can receive the designation of the location on the image of the store by receiving the information representing the location from the terminal device 11. As described above, the designated location identification unit 108 identifies store location information relevant to the designated location. Then, for example, the selection unit 109 selects the electronic shelf label D linked with the store location information as described above.

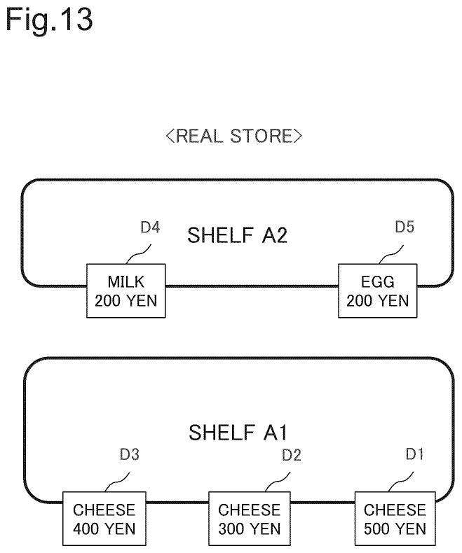

FIG. 13 is an explanatory view illustrating an example of the electronic shelf labels D in a real store. In FIG. 13, for example, the electronic shelf label D4 is selected. The electronic shelf label D4 and the electronic shelf label D5 are installed on the shelf A2. The electronic shelf label D4 is selected as the electronic shelf label D linked with the store location information relevant to the designated location.

Then, the second output control unit 111 may output merchandise information output to the selected electronic shelf label D to the terminal device 11 of the user.

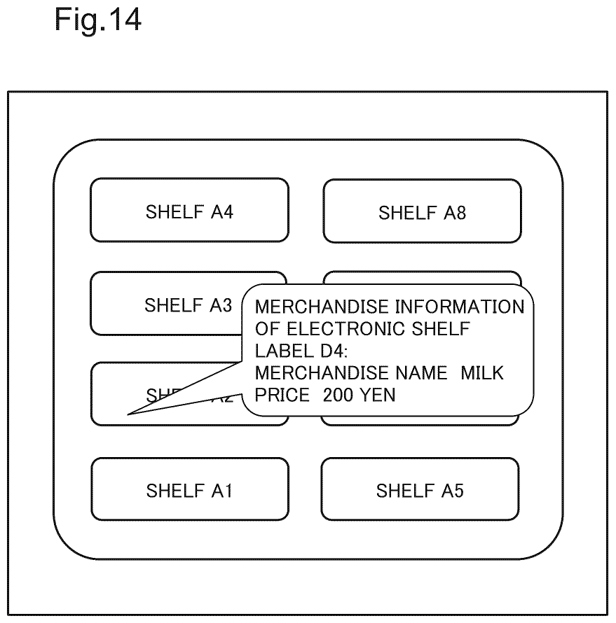

FIG. 14 is an explanatory view illustrating an example in which merchandise information displayed on the selected electronic shelf label D is displayed on the terminal device 11. In FIG. 14, the second output control unit 111 displays merchandise information output to the selected electronic shelf label D to be superimposed on the image of the store displayed on the terminal device 11 of the user.

Next, an example of changing merchandise information to be displayed on the selected electronic shelf label D will be described.

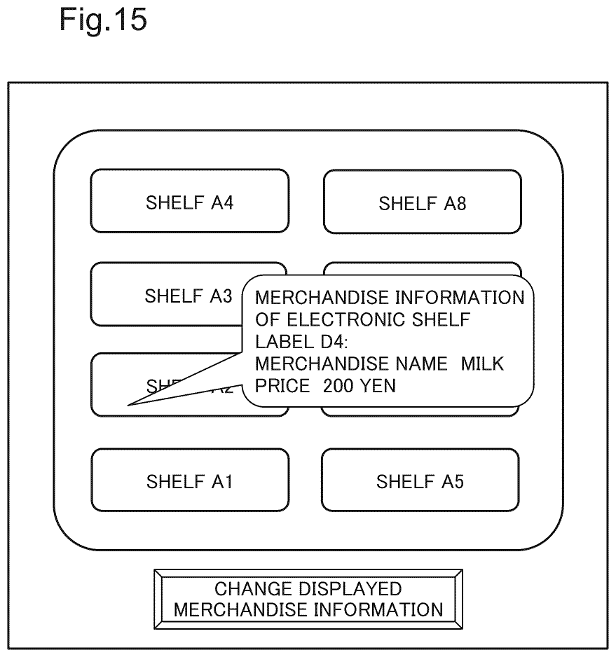

FIG. 15 is an explanatory view illustrating the example of changing the merchandise information to be displayed on the selected electronic shelf label D. A screen including a “change displayed merchandise information” button is displayed on the terminal device 11 together with the image of the store. This button is a button for receiving an instruction to input new merchandise information.

For example, when this button is tapped, the second output control unit 111 may display a screen capable of receiving new merchandise information on the display device of the terminal device 11.

Then, for example, the merchandise information reception unit 112 receives new merchandise information by an operation of the customer on the terminal device 11. The merchandise information reception unit 112 may update merchandise information linked with the identified store location information to the received merchandise information in the display merchandise DB 1001. Then, the first output control unit 104 displays the updated merchandise information on the display device 132 of the selected electronic shelf label D.

In the above drawings, description has been given with the example in which the image of the store is, for example, the image including the plurality of shelves installed in the store. For example, the image of the store may be an image that enables discernment of the front of a shelf installed in the store. The image that enables the discernment of the front of the shelf is an image obtained by capturing a state in which merchandise is displayed on the shelf and a state in which the electronic shelf label D is installed on the shelf.

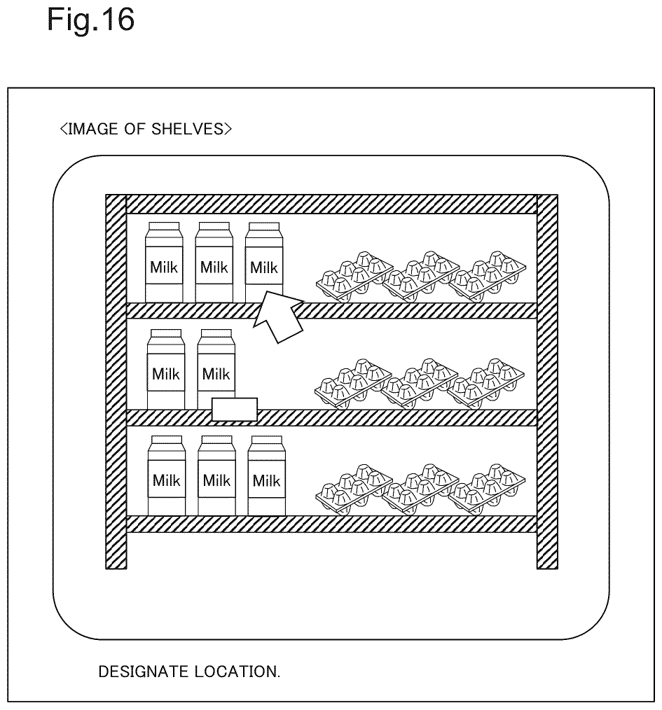

FIG. 16 is an explanatory view illustrating a second example of location designation on an image of a store. In FIG. 16, a screen including the image of the store is displayed on the terminal device 11. In FIG. 16, the image of the store is an image focusing on one shelf of the store, and is an image obtained by imaging of the shelf from the front. It is assumed that the shelf in FIG. 16 is the shelf A2. Although not illustrated, shelf identification information that enables identification of a shelf may be displayed on the image of the store. In FIG. 16, a mark indicating a location designated by a user operation may be displayed on the screen. In FIG. 16, this mark is an arrow.

As described above, the designated location identification unit 108 identifies store location information relevant to the designated location. Then, for example, the selection unit 109 selects the electronic shelf label D linked with the store location information as described above. Here, it is assumed that the electronic shelf label D4 has been selected.

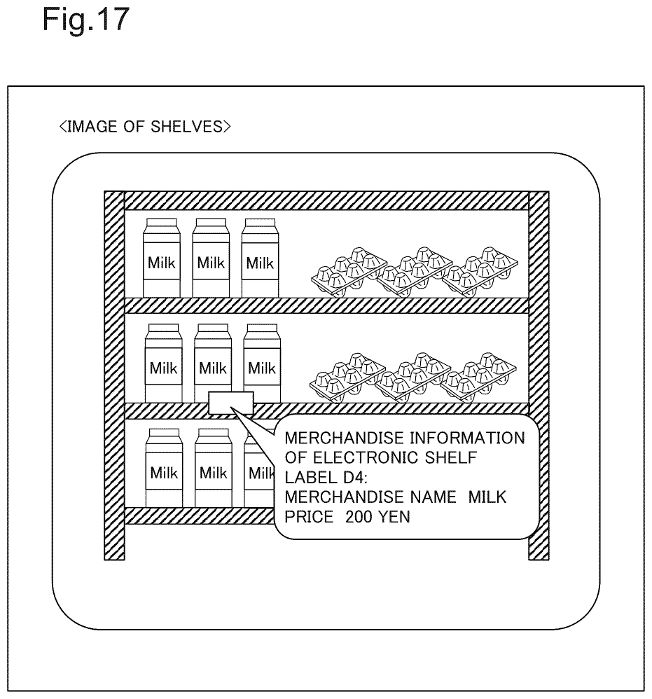

FIG. 17 is an explanatory view illustrating an example in which merchandise information displayed on the selected electronic shelf label D is displayed on the terminal device 11. In FIG. 17, the second output control unit 111 displays merchandise information output to the selected electronic shelf label D4 to be superimposed on the image of the store displayed on the terminal device 11 of the user.

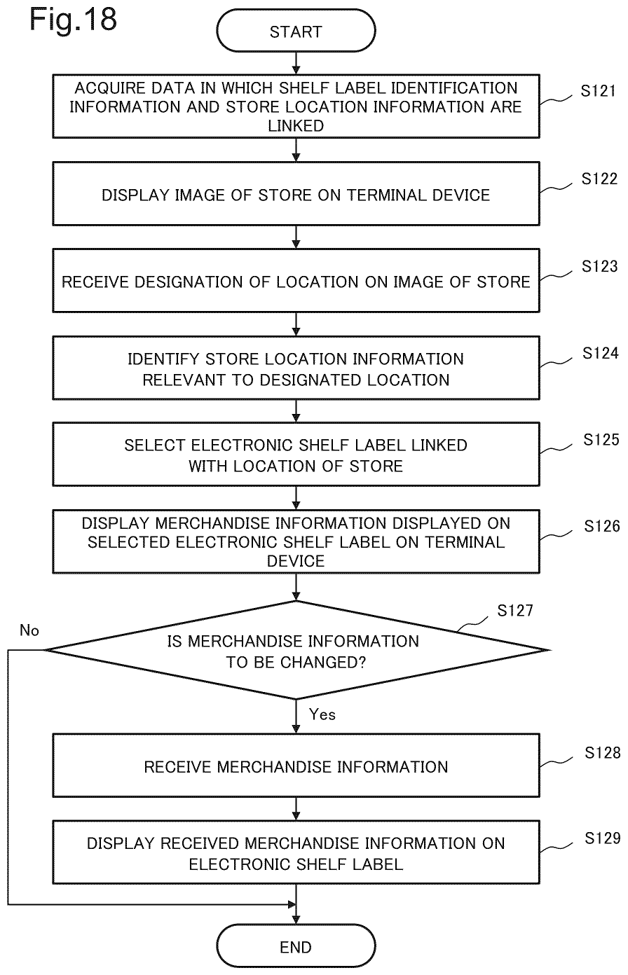

FIG. 18 is a flowchart illustrating an operation example regarding selection of the electronic shelf label D by the shelf label management system 10 according to the first example embodiment. The acquisition unit 101 acquires data in which shelf label identification information and store location information are linked (step S121). In step S121, for example, the acquisition unit 101 acquires the shelf label DB 1002. The second output control unit 111 displays an image of a store on the display device of the terminal device 11 (step S122).

The location reception unit 107 receives designation of a location on the image of the store (step S123). The designated location identification unit 108 identifies store location information relevant to the designated location (step S124). Here, each location on the image and location information in the facility relevant to this location may be linked in advance. In this case, in step S124, the location reception unit 107 identifies location information linked with the designated location. Alternatively, in step S124, the designated location identification unit 108 may estimate location information of the facility from a location of the imaging device 14 that has captured the image and an angle of view of the image. Alternatively, the designated location identification unit 108 may identify a shelf near an area of the designated location from the image, and estimate the location information of the facility from a location of the shelf.

The selection unit 109 selects the electronic shelf label D identified by shelf label identification information linked with the identified store location information based on the acquired shelf label DB 1002 (step S125). The second output control unit 111 displays, on the terminal device 11, merchandise information displayed on the selected electronic shelf label D (step S126). For example, in step S126, the second output control unit 111 identifies the merchandise information displayed on the electronic shelf label D from the store location information linked with the shelf label identification information of the selected electronic shelf label D based on the shelf label DB 1002 and the display merchandise DB 1001. Then, in step S126, the second output control unit 111 displays the identified merchandise information on the display device of the terminal device 11.

The merchandise information reception unit 112 determines whether to change the merchandise information (step S127). For example, in step S127, the merchandise information reception unit 112 determines whether to change the merchandise information depending on whether the button for changing merchandise information as illustrated in FIG. 15 is tapped. When the button for changing merchandise information is tapped, the merchandise information reception unit 112 determines to change the merchandise information.

In a case where it is not determined to change the merchandise information (step S127: No), the shelf label management system 10 ends the processing.

On the other hand, in a case where it is determined to change the merchandise information (step S127: Yes), the merchandise information reception unit 112 receives merchandise information (step S128). The first output control unit 104 displays the received merchandise information on the electronic shelf label D (step S129). Then, the shelf label management system 10 ends the processing.

As described above, identification information for identifying the electronic shelf label D is linked with location information representing a location in the facility for each of the electronic shelf labels D in the first example embodiment. Then, the shelf label management system 10 receives designation of a location on the image of the facility by the user operation, identifies location information of the facility relevant to the designated location, and selects the electronic shelf label D linked with the location information of the facility. As a result, it is possible to facilitate designation of the electronic shelf label D by the user. For example, the user can designate the electronic shelf label D without knowing where the electronic shelf label D is installed in the facility.

Furthermore, the shelf label management system 10 controls an output of the selected electronic shelf label D. For example, the shelf label management system 10 may turn on a lighting device of the selected electronic shelf label D. For example, the lighting device of the selected electronic shelf label D is turned on using the terminal device 11 when the user is walking while searching for the electronic shelf label D, so that the user can easily find the electronic shelf label D. Alternatively, for example, the shelf label management system 10 may output new merchandise information to the selected electronic shelf label D. As a result, the merchandise information displayed on the selected electronic shelf label D can be updated.

Furthermore, the shelf label management system 10 outputs the merchandise information output to the selected electronic shelf label D to the terminal device 11 of the user. As a result, the user can confirm the merchandise information displayed on the selected electronic shelf label D.

### <Notification Example of Shift of Electronic Shelf Label D>

An example in which a clerk is notified that the electronic shelf label D has been when the electronic shelf label D has been from a location represented by store location information linked in advance will be described.

After shelf label identification information of the electronic shelf label D and store location information are linked, the location identification unit 102 may newly identify store location information of the electronic shelf label D. A timing at which the location identification unit 102 newly identifies a location of the electronic shelf label D is not particularly limited. For example, this timing may be a timing designated by a user or may be a predetermined timing such as once a day or every predetermined time. For example, in the case of designation by the user, the instruction reception unit 105 may receive an instruction for identification of a location of the electronic shelf label D. Then, when the instruction reception unit 105 receives the instruction for identification, the location identification unit 102 newly identifies store location information of the electronic shelf label D, for example.

The determination unit 113 determines whether the newly identified store location information and the store location information linked with the shelf label identification information of the electronic shelf label D are different or the same. That is, the determination unit 113 determines whether the newly identified store location information is different from the store location information linked with the shelf label identification information of the electronic shelf label D. As a result, the determination unit 113 can determine whether a current location of an electronic shelf label is not a location where merchandise, identified by merchandise information displayed on the electronic shelf label, is displayed or is outside an area where the merchandise is displayed.

Then, in a case where it is determined that the newly identified store location information is different from the store location information linked with the shelf label identification information of the electronic shelf label D, the notification unit 106 notifies the user. With this configuration, in a case where the current location of the electronic shelf label is not the location where the merchandise, identified by the merchandise information displayed on the electronic shelf label, is displayed or is not in the area where the merchandise is displayed, the notification unit 106 can notify the user. A method for the notification is not particularly limited. The notification unit 106 may control an output of the electronic shelf label D such that the user can discern that the location of the electronic shelf label D has been shifted. For example, in a case where the LED 131 of the electronic shelf label D is controlled, the notification unit 106 may perform the notification by turning on the LED 131 in a predetermined mode such as causing the LED 131 of the electronic shelf label D to blink or turning on the LED 131 of the electronic shelf label D in a predetermined color.

Alternatively, for example, the notification unit 106 may notify the terminal device 11 used by the user using an electronic message or an electronic mail.

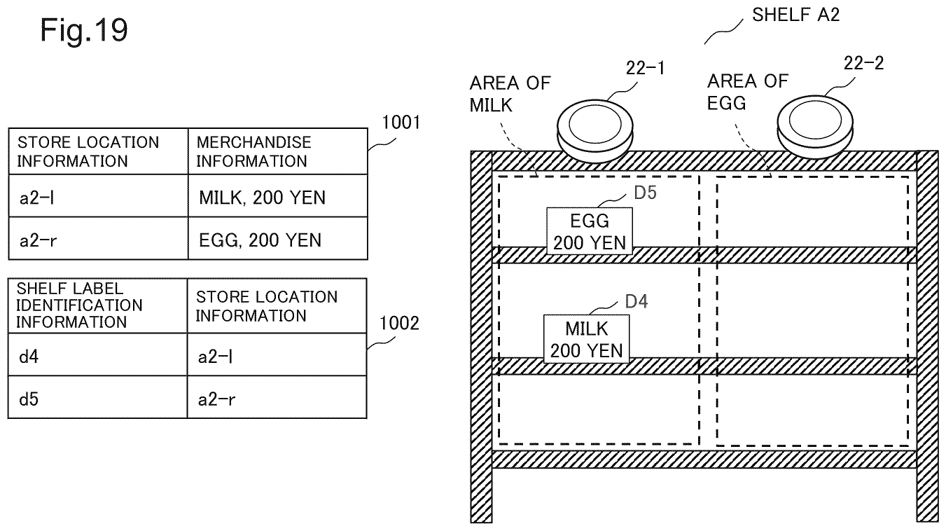

FIG. 19 is an explanatory view illustrating an example in which the electronic shelf label D is present in an area different from an area of linked merchandise. For example, in FIG. 19, on the electronic shelf label D5, a merchandise name “egg” and a price “200 yen” are displayed as merchandise information. In FIG. 19, the store location information a2-r is linked with the shelf label identification information d5 of an electronic shelf label D5 in accordance with the shelf label DB 1002. However, in FIG. 19, the location identification unit 102 identifies the store location information a2-1 when a location of the electronic shelf label D5 is newly measured.

The determination unit 113 determines that the newly identified store location information a2-1 is different from the store location information a2-r linked with the shelf label identification information d5 of the electronic shelf label D5. Therefore, the notification unit 106 notifies the user that the location of the electronic shelf label D5 has been shifted.

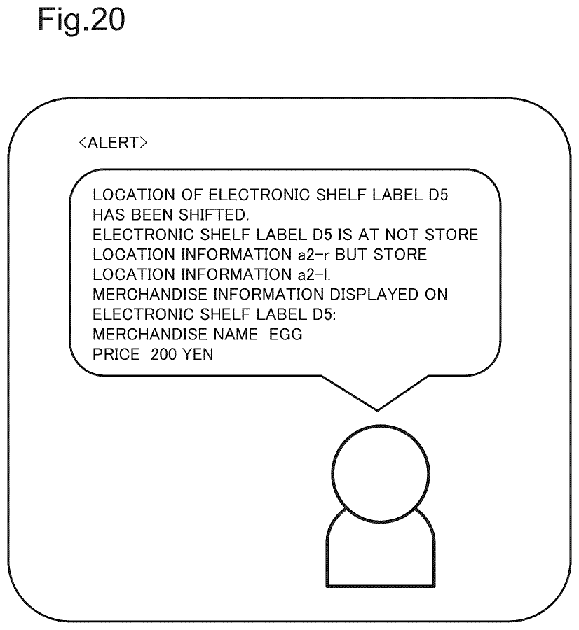

FIG. 20 is an explanatory view illustrating Notification Example 1. In FIG. 20, the notification unit 106 notifies the user that the location of the electronic shelf label D5 has been shifted via the second output control unit 111. Specifically, in FIG. 20, a screen including the fact that the location of the electronic shelf label D5 has been shifted is displayed on the terminal device 11 of the user. Furthermore, in FIG. 20, the screen includes store location information representing a current location of the electronic shelf label D and store location information linked with shelf label identification information of the electronic shelf label D.

Although not illustrated, the notification unit 106 may cause the second output control unit 111 to display, on the terminal device 11, an image of a map of a store and the current location represented by the store location information newly identified in the image of the map.

Furthermore, the notification unit 106 may also notify an image of a current shelf on which the electronic shelf label D is installed. For example, when the newly identified location information is different from the location information linked with the shelf label identification information of the electronic shelf label D, the imaging control unit 110 causes the imaging device 14 to capture the image of the shelf on which the electronic shelf label D is installed. Then, the imaging control unit 110 acquires the captured shelf image.

Here, the imaging device 14 may constantly capture shelf images or may capture a shelf image in response to an imaging instruction from the imaging control unit 110 when the newly identified location information is different from the location information linked with the shelf label identification information of the electronic shelf label D. For example, in a case where the imaging device 14 constantly captures shelf images, it is sufficient for the imaging control unit 110 to acquire, from the imaging device 14, a shelf image by which the difference between the newly identified location information and the location information linked with the shelf label identification information of the electronic shelf label D can be identified.

The image of the shelf on which the electronic shelf label D is installed may be an image of furniture at a location represented by the newly identified location information, or may be an image of furniture at a location represented by the location information linked with the shelf label identification information of the electronic shelf label D. Then, the notification unit 106 may perform the notification by transmitting the captured image to the terminal device 11 of the user. Alternatively, the notification unit 106 may perform the notification by displaying the captured image on the terminal device 11 of the user.

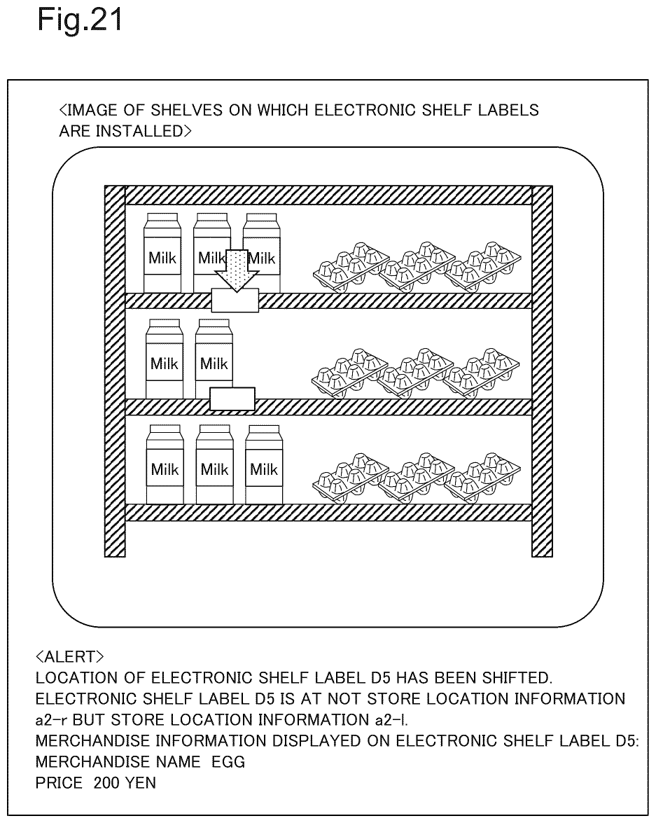

FIG. 21 is an explanatory view illustrating Notification Example 2. In FIG. 21, the notification unit 106 displays an image of a shelf on which the electronic shelf label D5 is installed on the terminal device 11 of the user via the second output control unit 111, and notifies that a location of the electronic shelf label D5 has been shifted. The notification unit 106 may identify the electronic shelf label D5 from the image and display a mark indicating the electronic shelf label D5 to be superimposed on the image. In FIG. 21, this mark is an arrow.

Furthermore, an area of the facility where merchandise is displayed may be determined in advance. The determination unit 113 may determine whether a current location of the electronic shelf label D is in an area of merchandise identified by store location information linked with shelf label identification information of the electronic shelf label D based on newly identified store location information. Then, in a case where the location of the electronic shelf label D is not in the area, the notification unit 106 notifies the user. A method for the notification is the same as described above.

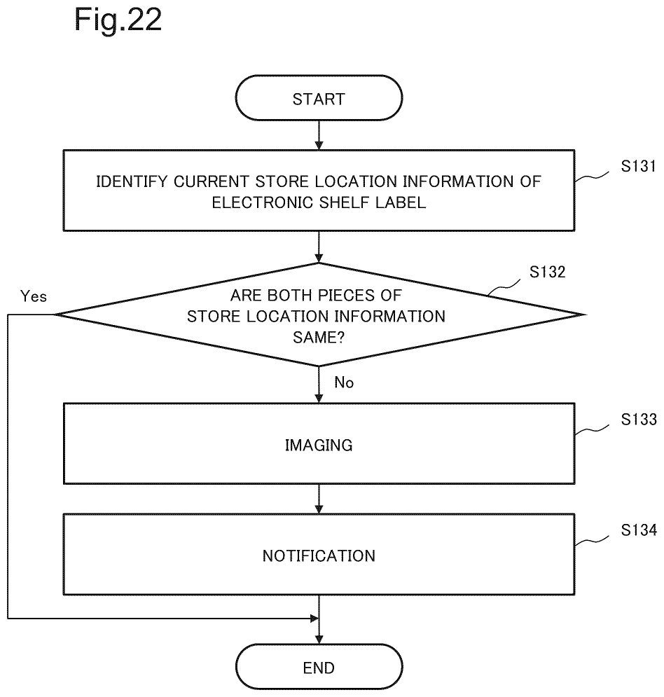

FIG. 22 is a flowchart illustrating an operation example regarding notification of a shift of a location of the electronic shelf label D by the shelf label management system 10 according to the first example embodiment. First, after shelf label identification information of the electronic shelf label D is linked with store location information, the location identification unit 102 identifies store location information representing a current location of the electronic shelf label D at a predetermined timing (step S131).

Next, the determination unit 113 determines whether the current store location information of the electronic shelf label D is the same as the store location information linked with the shelf label identification information of the electronic shelf label D in the shelf label DB 1002 (step S132). In a case where the current store location information of the electronic shelf label D and the store location information linked with the shelf label identification information of the electronic shelf label D in the shelf label DB 1002 are the same (step S132: Yes), the shelf label management system 10 ends the processing. On the other hand, in a case where the current store location information of the electronic shelf label D is different from the store location information linked with the shelf label identification information of the electronic shelf label D in the shelf label DB 1002 (step S132: No), the imaging control unit 110 causes the imaging device 14 to capture an image of a shelf on which the electronic shelf label D is installed (step S133). Then, the notification unit 106 notifies the user (step S134), and the shelf label management system 10 ends the processing.

As described above, the shelf label management system 10 notifies the user when a current location of the electronic shelf label D is different from a location linked with the electronic shelf label D in the first example embodiment. As a result, the user can grasp that a shift of the location of the electronic shelf label D has occurred.

Furthermore, the shelf label management system 10 also notifies the user of a shelf image captured in real time. This makes it easier for the user to confirm that the shift of the location of the electronic shelf label D has occurred.

### Second Example Embodiment

Next, a second example embodiment will be described in detail with reference to the drawings. In the second example embodiment, basic functions of a shelf label management system will be described. Hereinafter, description regarding contents overlapping with the above description will be omitted to the extent that description of the second example embodiment is not unclear.

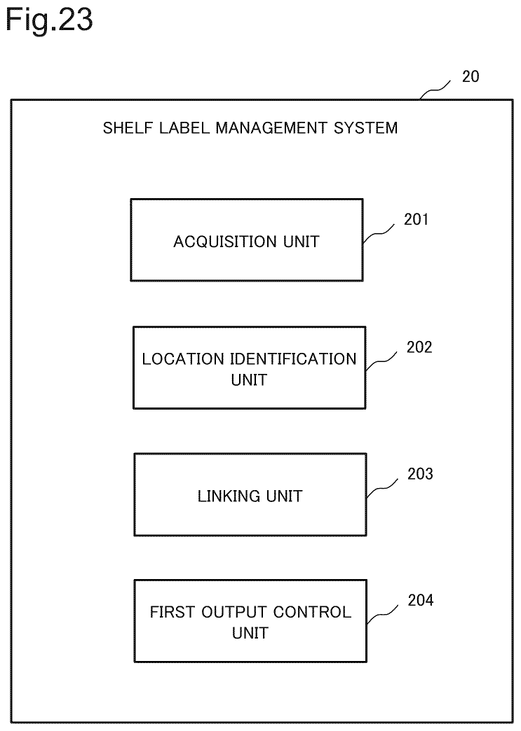

FIG. 23 is a block diagram illustrating a configuration example of the shelf label management system according to the second example embodiment. A shelf label management system 20 includes an acquisition unit 201, a location identification unit 202, a linking unit 203, and a first output control unit 204. The acquisition unit 201 is a basic function of the acquisition unit 101 in the first example embodiment. The location identification unit 202 is a basic function of the location identification unit 102 in the first example embodiment. The linking unit 203 is a basic function of the linking unit 103 in the first example embodiment. The first output control unit 204 is a basic function of the first output control unit 104 in the second example embodiment.

The acquisition unit 201 acquires, for each location in a facility, data in which location information representing the location and merchandise information of merchandise displayed near the location are linked. Although not illustrated, for example, it is sufficient that the location information and the merchandise information are stored in linkage with each other in a storage unit or the like, and the acquisition unit 201 acquires the linked data.

Upon receipt of an instruction to link a location of an electronic shelf label, the location identification unit 202 identifies location information representing the location of the electronic shelf label in a store. Specifically, for example, the location identification unit 202 identifies the location of the electronic shelf label in the facility. For example, the location identification unit 202 measures the location of the electronic shelf label based on communication strength of wireless communication with an apparatus fixedly arranged in the facility. Alternatively, the location identification unit 202 measures the location of the electronic shelf label based on communication strength of infrared communication with an apparatus fixedly arranged in the facility.

The linking unit 203 links the identified location information and shelf label identification information of the electronic shelf label. Specifically, for example, the linking unit 203 outputs the shelf label identification information of the electronic shelf label and the identified location information in linkage with each other. As an example of the output in linkage, the linking unit 203 stores the identification information of the electronic shelf label and the identified location information in linkage with each other in a storage unit or the like. As a result, an electronic shelf label and merchandise information are linked.

The first output control unit 204 outputs the merchandise information linked with the location information to the electronic shelf label based on the acquired data. Specifically, for example, the first output control unit 204 displays the merchandise information on a display device of the electronic shelf label. More specifically, for example, the first output control unit 204 displays the merchandise information on the display device of the electronic shelf label by wireless communication via the apparatus fixedly arranged in the store. Alternatively, for example, the first output control unit 204 displays the merchandise information on the display device of the electronic shelf label by infrared communication via the apparatus fixedly arranged in the facility.

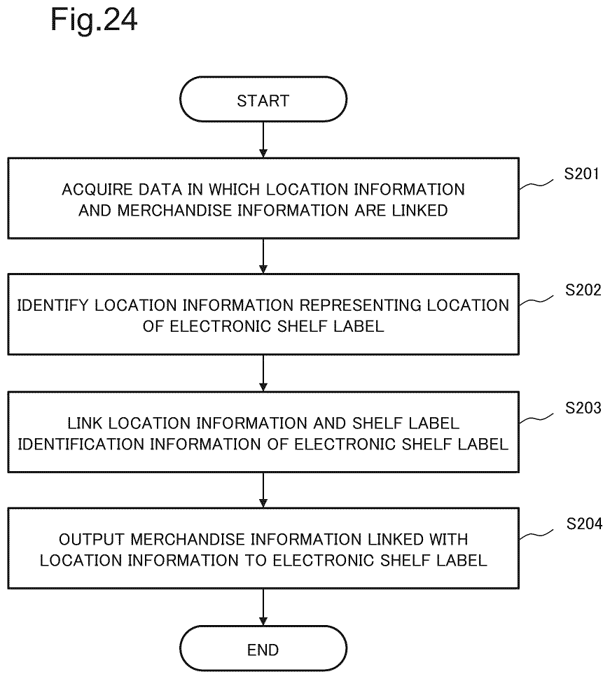

FIG. 24 is a flowchart illustrating an operation example of the shelf label management system 20 according to the second example embodiment. First, the acquisition unit 201 acquires data in which location information and merchandise information are linked (step S201). The location identification unit 202 identifies store location information representing a location of an electronic shelf label (step S202). The linking unit 203 links the identified location information and shelf label identification information of the electronic shelf label (step S203). The first output control unit 204 outputs the merchandise information linked with the location information to the electronic shelf label based on the acquired data (step S204).

As described above, location information representing a location and merchandise information of merchandise displayed near the location are linked with each location in the facility in the second example embodiment. Then, upon receipt of an instruction to link a location of an electronic shelf label, the shelf label management system 20 identifies location information representing the location where the electronic shelf label is arranged in the facility, and links identification information of the electronic shelf label with the identified location information. Then, the shelf label management system 20 outputs the merchandise information linked with the identified location information to the electronic shelf label based on data in which the location information and the merchandise information are linked. As a result, it is possible to save time and effort in the case of linking the location information with the electronic shelf label.

As described above, the description of the example embodiments is finished. The example embodiments may be used in combination. Furthermore, for example, in each of the example embodiments, the shelf label management system may include a part of the functional units and a part of the information.

Furthermore, the example embodiments are not limited to the above-described examples, and various changes can be made. Furthermore, the configuration of the shelf label management system in each of the example embodiments is not particularly limited. The shelf label management system may be achieved by one device such as one terminal device 11 or one server. Alternatively, the shelf label management system may be achieved by devices different for functions or types of data. Furthermore, the shelf label management system may include a plurality of servers.

Furthermore, a target to be transmitted and received between the shelf label management system and another device described in each of the example embodiments may be information itself or an identifier representing information, and is not particularly limited.

In the example embodiments, each piece of information may include a part of the above-described information. Furthermore, each piece of information may include information other than the above-described information. Each piece of information may be divided into a plurality of tables or a plurality of pieces of information in more detail. In this manner, a method for achieving each piece of information is not particularly limited.

Furthermore, the screens displayed on the terminal device 11 are examples, and are not particularly limited. In the screens, a button, a list, a check box, an information display field, an input field, and the like (not illustrated) may be added. Furthermore, background colors of the screens and the like may be changed.

Furthermore, for example, in the example embodiments, the processing of generating information of the screen to be displayed on the terminal device 11 or the like may be performed by the second output control unit of the shelf label management system or by the terminal device 11.

### (Hardware Configuration Example of Computer)

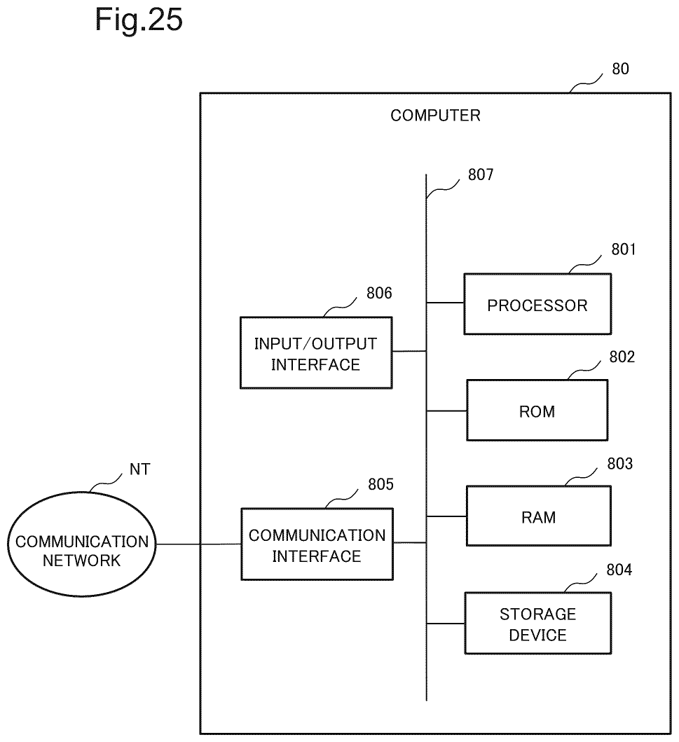

Next, a hardware configuration example in a case where each device such as the shelf label management system or the terminal device described in the example embodiments is achieved by a computer will be described. FIG. 25 is an explanatory diagram illustrating the hardware configuration example of the computer. For example, some or all of the devices can also be achieved by any combination of a computer 80 and a program as illustrated in FIG. 25, for example.

The computer 80 includes, for example, a processor 801, a read only memory (ROM) 802, a random access memory (RAM) 803, and a storage device 804. Furthermore, the computer 80 includes a communication interface 805 and an input/output interface 806. Components are connected to each other via, for example, a bus 807. The number of each of the components is not particularly limited, and one component or a plurality of the components are provided.

The processor 801 controls the entire computer 80. Examples of the processor 801 include a central processing unit (CPU), a digital signal processor (DSP), a graphics processing unit (GPU), and the like. The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each of the example embodiments, and the like. Alternatively, the ROM 802 stores an application program, the program according to each of the example embodiments, and the like. Then, the RAM 803 is used as a work area of the processor 801.

Furthermore, the processor 801 loads a program stored in the storage device 804, the ROM 802, or the like. Then, the processor 801 executes each processing coded in the program. Furthermore, the processor 801 may download various programs via the communication network NT. Furthermore, the processor 801 functions as a part or a whole of the computer 80. Then, the processor 801 may execute the processing in the illustrated flowchart or a command based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device and/or an external computer 80 via the communication network NT. The communication interface 805 serves as an interface between the communication network NT and the inside of the computer 80. Then, the communication interface 805 controls input and output of data from the external device and/or the external computer 80.

Furthermore, the input/output interface 806 is connected to at least any one of an input device, an output device, and an input/output device. A method for the connection may be wireless or wired. Examples of the input device include a keyboard, a mouse, a microphone, and the like. Examples of the output device include a display device, a lighting device, a speaker that outputs sound, and the like. Examples of the input/output device include a touch panel display and the like. The input device, the output device, the input/output device, and the like may be built in or externally attached to the computer 80.

The hardware configuration of the computer 80 is an example. The computer 80 may have some constituent elements illustrated in FIG. 25. The computer 80 may have constituent elements other than those illustrated in FIG. 25. For example, the computer 80 may include a drive device or the like. Then, the processor 801 may read a program and/or data, stored in a recording medium attached to the drive device or the like, into the RAM 803. Examples of a non-transitory tangible recording medium include an optical disk, a flexible disk, a magnetic optical disk, a universal serial bus (USB) memory, and the like. As described above, for example, the computer 80 may include an input device such as a keyboard or a mouse. The computer 80 may include an output device such as a display. Furthermore, the computer 80 may include the input device, the output device, and an input/output device.

The computer 80 may include various sensors (not illustrated). Types of the sensors are not particularly limited. Examples of the sensor include an acceleration sensor, a gyro sensor, a magnetic sensor, a global positioning system (GPS), a sensor, and the like. Examples of the sensor further include a fingerprint sensor, light detection and ranging (LiDAR), a proximity sensor, an ambient light sensor, and the like.

As described above, the description of hardware configurations of the devices is finished. Furthermore, there are various modifications in a method for achieving each of the devices. For example, each of the devices may be achieved by any combination of a computer and a program which are different for each of the constituent elements. Furthermore, a plurality of constituent elements included in each of the devices may be achieved by any combination of one computer and a program.

Furthermore, some or all of the constituent elements of each of the devices may be achieved by an application-specific circuit. Some or all of the constituent elements of each of the devices may be achieved by a general-purpose circuit including a processor such as a field programmable gate array (FPGA). Some or all of the constituent elements of each of the devices may be achieved by a combination of an application-specific circuit, a general-purpose circuit, and the like. Furthermore, these circuits may be a single integrated circuit. Alternatively, these circuits may be divided into a plurality of integrated circuits. Then, the plurality of integrated circuits may be connected via a bus or the like.

Furthermore, in a case where some or all of the constituent elements of each of the devices are achieved by a plurality of computers, circuits, or the like, the plurality of computers, circuits, or the like may be arranged in a centralized manner or in a distributed manner.

A shelf label management method described in each of the example embodiments is achieved by being executed by the shelf label management system. Furthermore, for example, the shelf label management method is achieved as a computer, such as a server or the terminal device 11, executes a program prepared in advance. The program described in each of the example embodiments is recorded in a computer-readable recording medium such as an HDD, an SSD, a flexible disk, an optical disk, a flexible disk, a magnetic optical disk, or a USB memory. Then, the program is executed by being read from the recording medium by the computer. Furthermore, the program may be distributed via the communication network NT.

The function of each of the constituent elements of the shelf label management system in the example embodiments described above may be achieved in a hardware manner as in a computer. Alternatively, each of the constituent elements may be achieved by a computer or firmware based on program control.

Although the present disclosure has been described with reference to the example embodiments, the present disclosure is not limited to the above example embodiments. The configurations and details of the present disclosure may include example embodiments to which various changes that can be grasped by those skilled in the art within a scope of the present disclosure are applied. The present disclosure may include example embodiments in which matters described in the present specification are appropriately combined or replaced as necessary. For example, matters described using a specific example embodiment can also be applied to another example embodiment within a range that does not cause contradiction. For example, a plurality of operations are described in order in a format of a flowchart, the order of description does not limit the order of executing the plurality of operations. Therefore, when each of the example embodiments is implemented, the order of the plurality of operations can be changed within a range that does not interfere with the contents.

Some or all of the above example embodiments can also be described as the following supplementary notes. However, some or all of the above example embodiments are not limited to the following.

### Supplementary Note 1

A shelf label management system including:
an acquisition means for acquiring, for each location in a facility, data in which location information representing the location and merchandise information relating to merchandise displayed near the location are linked;
a location identification means for identifying location information representing a location where an electronic shelf label is arranged in the facility upon receipt of an instruction to link the location of the electronic shelf label;
a linking means for linking the identified location information and shelf label identification information of the electronic shelf label; and
a first output control means for outputting merchandise information linked with the identified location information to the electronic shelf label based on the acquired data.

### Supplementary Note 2

The shelf label management system according to Supplementary Note 1, wherein
the location identification means measures a location of the electronic shelf label by wireless communication between the electronic shelf label and an apparatus fixedly arranged in the facility.

### Supplementary Note 3

The shelf label management system according to Supplementary Note 1, wherein
the location identification means measures a location of the electronic shelf label by infrared communication between the electronic shelf label and an apparatus fixedly arranged in the facility.

### Supplementary Note 4

The shelf label management system according to any one of Supplementary Notes 1 to 3, wherein
in a case where pieces of the identified location information of a plurality of electronic shelf labels are identical, the linking means links the identified location information in such a way that different merchandise information is allocated to shelf label identification information of each of the plurality of electronic shelf labels.

### Supplementary Note 5

The shelf label management system according to Supplementary Note 4, wherein
when the number of the plurality of electronic shelf labels is larger than the number of pieces of merchandise identified by the merchandise information linked with the identified location information, the linking means links the identified location information in such a way that different merchandise information is allocated to shelf label identification information of each of electronic shelf labels corresponding to the number of pieces of the merchandise among the plurality of electronic shelf labels.

### Supplementary Note 6

The shelf label management system according to any one of Supplementary Notes 1 to 5, further including
a notification means for notifying a user,
wherein the location identification means newly identifies location information representing a location of the electronic shelf label in the facility after the shelf label identification information of the electronic shelf label and the identified location information are linked, and
the notification means notifies the user when the newly identified location information is different from the location information linked with the shelf label identification information of the electronic shelf label.

### Supplementary Note 7

The shelf label management system according to Supplementary Note 6, further including
an imaging control means for causing an imaging device to capture an image of furniture on which the electronic shelf label is installed when the newly identified location information is different from the location information linked with the shelf label identification information of the electronic shelf label,
wherein the notification means transmits the captured image to a terminal device of the user.

### Supplementary Note 8

The shelf label management system according to any one of Supplementary Notes 1 to 7, further including:
a location reception means for receiving designation of a location on an image of the facility by an operation of a user;
a location identification means for identifying a location of the facility relevant to the designated location; and
a selection means for selecting an electronic shelf label linked with the location of the facility.

### Supplementary Note 9

The shelf label management system according to Supplementary Note 8, wherein
the first output control means controls an output of the selected electronic shelf label.

### Supplementary Note 10

The shelf label management system according to Supplementary Note 9, further including
a second output control means for displaying information displayed on the selected electronic shelf label on a terminal device of the user.

### Supplementary Note 11

The shelf label management system according to any one of Supplementary Notes 1 to 10, wherein
the facility is at least any one of a store, a factory, and a warehouse.

### Supplementary Note 12

A shelf label management method including:
acquiring, for each location in a facility, data in which location information representing the location and merchandise information relating to merchandise displayed near the location are linked;
identifying location information representing a location where an electronic shelf label is arranged in the facility upon receipt of an instruction to link the location of the electronic shelf label;
linking the identified location information and shelf label identification information of the electronic shelf label; and
outputting merchandise information linked with the identified location information to the electronic shelf label based on the acquired data.

### Supplementary Note 13

A non-transitory computer-readable recording medium that records a program for causing a computer to execute processing of:
acquiring, for each location in a facility, data in which location information representing the location and merchandise information relating to merchandise displayed near the location are linked;
identifying location information representing a location where an electronic shelf label is arranged in the facility upon receipt of an instruction to link the location of the electronic shelf label;
linking the identified location information and shelf label identification information of the electronic shelf label; and
outputting merchandise information linked with the identified location information to the electronic shelf label based on the acquired data.

### Supplementary Note 14

A program causing a computer to execute processing of:
acquiring, for each location in a facility, data in which location information representing the location and merchandise information relating to merchandise displayed near the location are linked;
identifying location information representing a location where an electronic shelf label is arranged in the facility upon receipt of an instruction to link the location of the electronic shelf label;
linking the identified location information and shelf label identification information of the electronic shelf label; and
outputting merchandise information linked with the identified location information to the electronic shelf label based on the acquired data.

### REFERENCE SIGNS LIST

10, 20 shelf label management system
11 terminal device
12, 12-1, 12-2 apparatus
14 imaging device
80 computer
101, 201 acquisition unit
102, 202 location identification unit
103, 203 linking unit
104, 204 first output control unit
105 instruction reception unit
106 notification unit
107 location reception unit
108 designated location identification unit
109 selection unit
110 imaging control unit
111 second output control unit
112 merchandise information reception unit
113 determination unit
131 LED
132 display device
801 processor
802 ROM
803 RAM
804 storage device
805 communication interface
806 input/output interface
807 bus
a2-1, a2-1-1, a2-1-2, a2-r store location information
A1, A2, A3, A4, A5, A6, A7, A8 shelf
D, D1, D2, D3, D4, D5, D6 electronic shelf label
1001 display merchandise DB
1002 shelf label DB
NT communication network

What is claimed is:

1. A shelf label management system comprising:
at least one memory storing instructions; and
at least one processor configured to execute the instructions to:
acquire, for each location in a facility, data in which location information representing the location and merchandise information relating to merchandise displayed near the location are linked;
identify location information representing a location where an electronic shelf label is arranged in the facility upon receipt of an instruction to link the location of the electronic shelf label;
link the identified location information and shelf label identification information of the electronic shelf label; and
output merchandise information linked with the identified location information to the electronic shelf label based on the acquired data.

2. The shelf label management system according to claim 1, wherein the at least one processor is further configured to execute the instructions to:
measure a location of the electronic shelf label by wireless communication between the electronic shelf label and an apparatus fixedly arranged in the facility.

3. The shelf label management system according to claim 1, wherein the at least one processor is further configured to execute the instructions to:
measure a location of the electronic shelf label by infrared communication between the electronic shelf label and an apparatus fixedly arranged in the facility.

4. The shelf label management system according to claim 1, wherein the at least one processor is further configured to execute the instructions to:
when the identified location information of a plurality of electronic shelf labels are identical, link the identified location information in such a way that different merchandise information is allocated to shelf label identification information of each of the plurality of electronic shelf labels.

5. The shelf label management system according to claim 4, wherein the at least one processor is further configured to execute the instructions to:
when a number of the plurality of electronic shelf labels is larger than a number of pieces of merchandise identified by the merchandise information linked with the identified location information, link the identified location information in such a way that different merchandise information is allocated to shelf label identification information of each of electronic shelf labels corresponding to the number of pieces of the merchandise among the plurality of electronic shelf labels.

6. The shelf label management system according to claim 1, wherein the at least one processor is further configured to execute the instructions to:
notify a user,
newly identify location information representing a location of the electronic shelf label in the facility after the shelf label identification information of the electronic shelf label and the identified location information are linked, and
notify the user when the newly identified location information is different from the location information linked with the shelf label identification information of the electronic shelf label.

7. The shelf label management system according to claim 6, wherein the at least one processor is further configured to execute the instructions to:
capture, with an imaging device, an image of furniture on which the electronic shelf label is installed when the newly identified location information is different from the location information linked with the shelf label identification information of the electronic shelf label,
transmit the captured image to a terminal device of the user.

8. The shelf label management system according to claim 1, wherein the at least one processor is further configured to execute the instructions to:
receive designation of a location on an image of the facility by an operation of a user;
identify a location of the facility relevant to the designated location; and
select an electronic shelf label linked with the location of the facility.

9. The shelf label management system according to claim 8, wherein the at least one processor is further configured to execute the instructions to:
control an output of the selected electronic shelf label.

10. The shelf label management system according to claim 9, the at least one processor is further configured to execute the instructions to:
display information displayed on the selected electronic shelf label on the terminal device of the user.

11. The shelf label management system according to claim 1, wherein
the facility is at least any one of a store, a factory, and a warehouse.

12. A shelf label management method comprising:
acquiring, for each location in a facility, data in which location information representing the location and merchandise information relating to merchandise displayed near the location are linked;
identifying location information representing a location where an electronic shelf label is arranged in the facility upon receipt of an instruction to link the location of the electronic shelf label;
linking the identified location information and shelf label identification information of the electronic shelf label; and
outputting merchandise information linked with the identified location information to the electronic shelf label based on the acquired data.

13. A non-transitory computer-readable recording medium that records a program for causing a computer to execute processing of:
acquiring, for each location in a facility, data in which location information representing the location and merchandise information relating to merchandise displayed near the location are linked;
identifying location information representing a location where an electronic shelf label is arranged in the facility upon receipt of an instruction to link the location of the electronic shelf label;
linking the identified location information and shelf label identification information of the electronic shelf label; and
outputting merchandise information linked with the identified location information to the electronic shelf label based on the acquired data.
